(19) United States
(12) Patent Application Publication
(10) Pub. No.: US 2026/0248269 A1
(43) Pub. Date: Aug. 27, 2026

(54) Removable and Replaceable Sub-Bristle Carrier Architecture for Oral Care Devices

(71) Applicant: Jephtephan Sabine Innocent, Charlotte, NC (US)

(72) Inventor: Jephtephan Sabine Innocent, Charlotte, NC (US)

(73) Assignee: DentaTech Innovations LLC, Charlotte, NC (US)

(21) Appl. No.: 19/530,476

(22) Filed: Feb. 5, 2026

(51) Int. Cl. A46B 7/04; A46B 9/04; A46B 13/02; A46B 15/00; A61C 17/22

(52) U.S. Cl. CPC A46B 7/042; A46B 9/04; A46B 15/0038; A46B 15/0093; A46B 13/02; A61C 17/222

(57) ABSTRACT

I disclose a modular oral care architecture incorporating a removable and replaceable sub-bristle carrier that forms only a portion of a toothbrush head. The sub-bristle carrier supports primary oral-contact cleaning elements and is detachably coupled to a host toothbrush head structure via a defined interface. The architecture permits selective removal and replacement of the sub-bristle carrier while the host toothbrush head structure remains attached to a toothbrush handle. The disclosed systems, components, methods, and replacement kits improve hygiene, reduce waste, and enable modular replacement of consumable cleaning elements without requiring replacement of the entire toothbrush head. The architecture is compatible with manual, powered, and hybrid toothbrushes.

### CROSS REFERENCE TO RELATED APPLICATIONS

This application claims the benefit of and priority to U.S. Provisional Patent Application No. 63/967,466, filed on Jan. 24, 2026, entitled “Modular Removable Sub-Brush Carrier Architecture for Cleaning Devices,” the entirety of which is incorporated herein by reference.

### TECHNICAL FIELD

I disclose systems and components for oral care devices, and more particularly modular toothbrush head architectures incorporating a removable and replaceable sub-bristle carrier that forms only a portion of a toothbrush head while interfacing with a larger, durable head structure. The disclosure applies to manual, powered, and hybrid toothbrushes and to modular cleaning systems in which consumable cleaning interfaces are decoupled from durable structural components.

### BACKGROUND

Oral care devices commonly incorporate bristles or other cleaning elements that are permanently fixed to a toothbrush head. In both manual and powered toothbrush designs, the bristle-bearing region is typically integrated as a non-removable portion of the head, even where the bristle region may rotate, oscillate, or otherwise move relative to the handle during use. This fixed integration limits access to the base of the bristles and adjacent structural regions, making thorough cleaning, rinsing, and drying difficult.

Over time, moisture, debris, toothpaste residue, and biological matter tend to accumulate at the bristle base and within adjacent recesses of the toothbrush head. Because these regions are not directly accessible, users are unable to adequately clean or dry them, leading to hygiene degradation and premature replacement of otherwise functional toothbrush heads. In many cases, the bristle region becomes worn or contaminated well before the surrounding head framework or internal components reach the end of their usable life.

Existing toothbrush architectures generally require replacement of the entire head assembly once the bristles are worn or hygiene concerns arise. This approach results in unnecessary material waste, increased costs to the user, and limited modularity. It also restricts the ability to selectively replace or interchange specialized cleaning interfaces for different use cases, preferences, or stages of wear, as the bristle-bearing portion is inseparable from the head structure.

Attempts to improve toothbrush hygiene have largely focused on external cleaning accessories, sanitization devices, or changes to bristle materials, rather than addressing the underlying architectural limitations created by permanently fixed bristle regions. Such approaches do not resolve the fundamental issue that the bristle-bearing portion itself is not designed to be accessed, removed, or independently maintained.

Additionally, permanently integrated bristle regions constrain future system integration and innovation. As toothbrush heads increasingly incorporate additional structural, mechanical, or functional features, the inability to separate consumable cleaning elements from durable head frameworks becomes a significant limitation to product longevity, sustainability, and modular design.

Accordingly, there exists a need for an oral care device architecture that structurally separates the bristle-bearing portion from the remainder of the toothbrush head, allowing selective removal and replacement of the bristle region alone. Such an architecture should enable improved hygiene and maintenance, reduce waste, support modular replacement systems, and remain compatible with both manual and powered toothbrush configurations, while resisting unintended detachment during normal use.

### SUMMARY

The present disclosure provides a modular oral care architecture incorporating a removable and replaceable sub-bristle carrier that forms only a portion of a toothbrush head while interfacing with a larger host head framework. The architecture is applicable to manual, powered, and hybrid toothbrush configurations and enables selective removal and replacement of the bristle-bearing region independently of the surrounding head structure.

In one aspect, the invention comprises a toothbrush head including a host head framework configured for attachment to a handle and at least one sub-bristle carrier removably coupled to the host head framework. The sub-bristle carrier supports a plurality of oral-contact cleaning elements and is retained within a defined receptacle region of the host head framework via a mechanical interface. The interface is configured to permit intentional detachment for cleaning or replacement while resisting unintended separation during normal brushing use.

The sub-bristle carrier constitutes a consumable modular component distinct from the host head framework. This separation allows the bristle-bearing region—where wear, contamination, and hygiene degradation most commonly occur—to be independently removed, rinsed, dried, soaked, replaced, or substituted without discarding the entire toothbrush head. The host head framework may remain attached to the handle during carrier removal and replacement, thereby preserving structural, mechanical, or functional elements unrelated to the carrier itself.

In various embodiments, the removable coupling between the sub-bristle carrier and the host head framework may be achieved using one or more attachment mechanisms, including but not limited to twist-lock interfaces, bayonet couplings, snap-fit detents, press-fit interference structures, magnetic alignment elements combined with mechanical retention features, or hybrid coupling systems. The interface may require a non-axial, compound, or deliberate alignment motion to disengage the carrier, thereby reducing the likelihood of accidental release during use.

The architecture further incorporates passive safety characteristics arising from structural design rather than user instruction. Such characteristics may include carrier dimensions, geometric profiles, interface orientations, and retention thresholds selected to discourage unintended detachment and mitigate risks associated with inadvertent release during oral use. These features function collectively to enhance safety while supporting ease of intentional removal.

By structurally separating the bristle-bearing region from the host head framework, the disclosed architecture improves hygiene by enabling direct access to regions that are otherwise difficult to clean or dry. The architecture further reduces material waste, extends the usable life of toothbrush heads, and supports modular replacement systems, including replacement carriers, multi-carrier assortments, and specialized carrier kits.

The disclosed system is not limited to a particular bristle configuration, carrier geometry, attachment mechanism, manufacturing process, or material selection. Multiple embodiments, alternatives, and equivalents are contemplated, and features described in connection with one embodiment may be combined with features of other embodiments. The Disclosed Architecture provides a foundational modular architecture intended to support future system expansion, product variation, and independent replacement ecosystems.

### BRIEF DESCRIPTION OF THE DRAWINGS

The accompanying drawings illustrate representative embodiments of the disclosed removable sub-bristle carrier architecture. The drawings are schematic and not to scale, and like reference numerals refer to like features throughout.

FIG. 1 is a perspective view of a removable sub-bristle carrier in a detached state, showing oral-contact cleaning elements supported by a carrier body.

FIG. 2 is a perspective view of the removable sub-bristle carrier installed within a host toothbrush head structure.

FIG. 3 is a perspective view of the host toothbrush head structure with the sub-bristle carrier removed, illustrating a carrier receptacle region and interface features.

FIG. 4 is a cross-sectional view through the interface between the removable sub-bristle carrier and the host toothbrush head structure, showing complementary engagement features.

FIG. 5 is an exploded view illustrating the removable sub-bristle carrier, interface region, and host toothbrush head structure in relative alignment prior to assembly.

FIG. 6 illustrates multiple removable sub-bristle carrier configurations having differing geometries and cleaning element arrangements, each configured to interface with a common host toothbrush head structure.

### DETAILED DESCRIPTION

### 4. System Overview

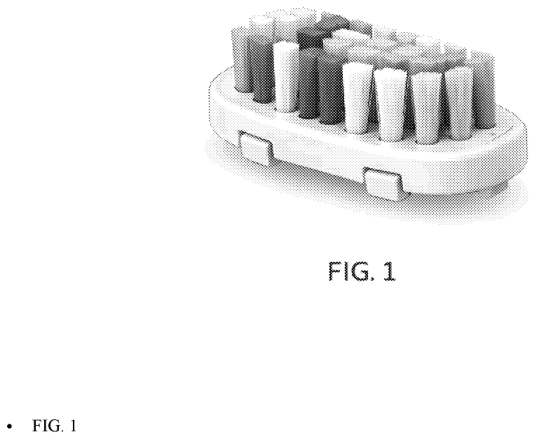

Referring now to FIGS. 1-3, the disclosed modular oral care architecture comprises a toothbrush head assembly including a host head framework and at least one removable sub-bristle carrier. The sub-bristle carrier forms only a portion of the toothbrush head and is removably coupled to the host head framework via a defined interface region.

As shown in FIG. 1, the sub-bristle carrier is illustrated in a detached state, separate from the host head framework. In this configuration, the carrier is fully accessible for rinsing, cleaning, drying, inspection, replacement, or substitution. The carrier supports the primary oral-contact cleaning elements, while the host head framework remains structurally intact and separate from the carrier.

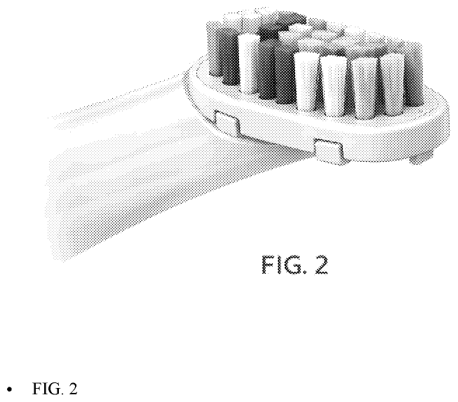

As shown in FIG. 2, the sub-bristle carrier is installed within a receptacle region of the host head framework. When installed, the carrier occupies a defined portion of the toothbrush head and cooperates with surrounding framework structures to present a unified oral-contact surface during brushing. In this installed state, the carrier is retained by one or more interface features that permit intentional removal while resisting unintended detachment during normal use.

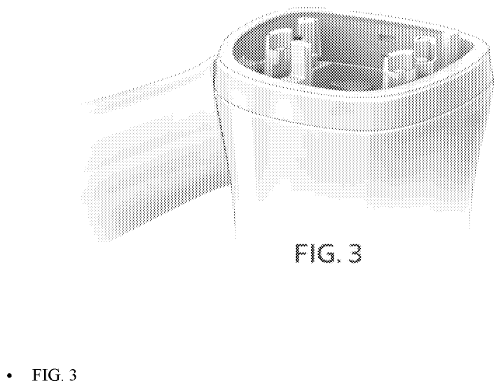

As shown in FIG. 3, the host head framework is depicted without the sub-bristle carrier installed. The host head framework defines a carrier-receiving region that may include one or more of: a recessed cavity, peripheral support walls, alignment features, retention structures, stop surfaces, or load-bearing interfaces. The host head framework is configured to remain attached to a toothbrush handle during carrier removal and replacement and may include structural, mechanical, or functional components unrelated to the carrier itself.

The sub-bristle carrier is a discrete modular component that includes a carrier body defining a finite thickness and perimeter and a plurality of cleaning elements extending from a surface. The cleaning elements may include bristles or other oral-contact projections suitable for mechanical cleaning of teeth and surrounding surfaces. Interface features are disposed on a second surface or perimeter of the carrier body and are configured to engage complementary interface features of the host head framework.

The host head framework serves as a durable structural platform that supports the removable carrier and interfaces with a toothbrush handle. The framework may be configured for attachment to manual, powered, or hybrid toothbrush handles using any suitable coupling mechanism.

The host head framework may further be configured to support one or more removable sub-bristle carriers in a single head assembly, including embodiments employing multiple carriers arranged in adjacent or spaced-apart configurations.

In the illustrated embodiments, the sub-bristle carrier makes up the primary consumable portion of the toothbrush head, while the host head framework constitutes a reusable portion intended to remain in service across multiple carrier replacement cycles. This separation allows wear, contamination, or hygiene degradation of the cleaning elements to be addressed independently of the surrounding head structure.

The architecture shown in FIGS. 1-3 is illustrative and non-limiting. The number, size, shape, orientation, and placement of sub-bristle carriers may vary. Likewise, the geometry and configuration of the host head framework may be adapted to accommodate different carrier designs, handle interfaces, or product form factors without departing from the scope of The Disclosed Architecture.

### 4.2 Sub-Bristle Carrier Structure

Referring now to FIGS. 1, 4, and 6, the sub-bristle carrier is a discrete, removable module configured to support oral-contact cleaning elements while forming only a portion of a toothbrush head. The carrier is structurally independent from the surrounding host head framework and is configured for repeated attachment and detachment without loss of functional integrity.

### Carrier Body

The sub-bristle carrier includes a carrier body defining a finite thickness and a perimeter profile sized to be received within a corresponding receptacle region of the host head framework. The carrier body may be rigid, semi-rigid, elastomeric, or hybrid in construction, and may be formed as a single-material component or as a multi-material assembly.

The carrier body defines: a first surface from which a plurality of cleaning elements extends; and a second surface and/or perimeter region that includes interface features for coupling to the host head framework.

The thickness, footprint, and mass of the carrier body may be selected to balance durability, hygiene accessibility, retention stability, and ease of handling during removal and replacement.

### Cleaning Elements

A plurality of cleaning elements extends from the first surface of the carrier body. The cleaning elements may include bristles, filaments, projections, fins, nubs, blades, or combinations thereof. The cleaning elements may be formed integrally with the carrier body or may be inserted, over molded, or otherwise secured to the carrier body.

The Disclosed Architecture does not rely on any particular bristle shape, material, or arrangement for novelty. Rather, the cleaning elements are supported by the carrier as a consumable interface that may be replaced independently of the surrounding head structure. Cleaning elements may vary in length, stiffness, density, orientation, or material depending on the intended use or replacement configuration.

### Carrier Geometry Variants

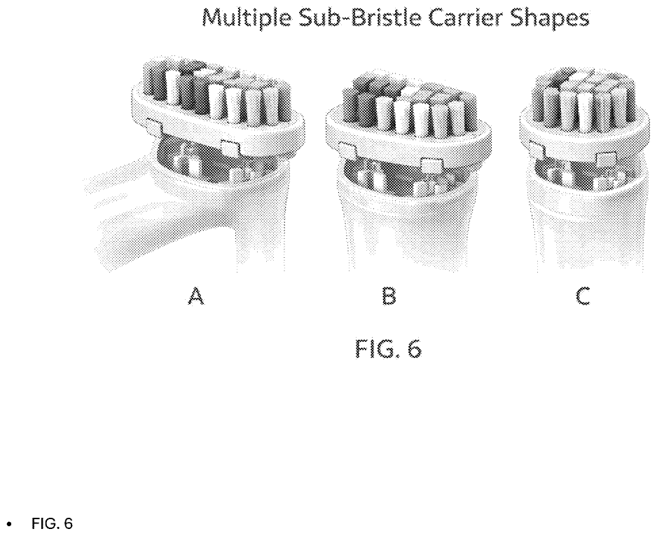

As illustrated in FIG. 6, the sub-bristle carrier may assume a variety of geometries while retaining a common interface architecture. Non-limiting examples include: circular carriers, oval or elliptical carriers, polygonal carriers, asymmetric carriers, or segmented carriers configured to cooperate with adjacent carriers.

Carrier geometry may be selected based on head design, desired coverage area, mechanical stability, or compatibility with manual or powered toothbrush heads. Multiple carrier shapes may be configured to interface with the same host head framework, enabling interchangeability and modular replacement systems.

### Interface Features on the Carrier

The carrier body includes one or more interface features configured to engage complementary interface features of the host head framework. Such interface features may be disposed on the second surface of the carrier body, along the perimeter, or both.

Interface features may include, without limitation: protrusions, lugs, or tabs, recesses, grooves, or channels, keyed profiles, ramps or cam surfaces, magnetic elements combined with mechanical engagement structures, retention shoulders or undercuts.

The interface features are configured to permit intentional disengagement while resisting incidental forces encountered during normal brushing. In some embodiments, disengagement requires a compound motion, non-axial motion, or deliberate alignment step.

### Structural Integrity and Wear Considerations

The carrier body and interface features are designed to accommodate repeated attachment and detachment cycles over the expected life of the toothbrush head. Wear surfaces may be reinforced, chamfered, radiused, or otherwise shaped to control wear patterns and maintain consistent retention characteristics over time.

In some embodiments, wear is intentionally biased toward the carrier rather than the host head framework, such that replacement of the carrier restores functional performance without degradation of the head framework.

### Multi-Carrier and Segmented Embodiments

In certain embodiments, a toothbrush head may include multiple sub-bristle carriers arranged within a single host head framework. Such carriers may be identical or different in size, shape, or function. Carriers may be arranged adjacently, concentrically, or in spaced configurations.

Segmented carrier embodiments may be employed to enable partial replacement, specialized cleaning modules, or staged wear management.

### Non-Limiting Nature of Examples

The carrier structures illustrated in FIGS. 1, 4, and 6 are exemplary and non-limiting. Variations in carrier geometry, interface design, material selection, and cleaning element configuration may be employed without departing from the scope of The Disclosed Architecture. Structural features described in connection with one embodiment may be combined with features of other embodiments.

### 4.3 Host Head Framework and Carrier Receptacle Architecture

Referring now to FIGS. 2-5, the toothbrush head assembly includes a host head framework configured to receive, retain, and support at least one removable sub-bristle carrier. The host head framework functions as a durable structural platform distinct from the consumable carrier and is intended to remain in service across multiple carrier replacement cycles.

### Host Head Framework Structure

The host head framework defines a carrier receptacle region configured to receive the sub-bristle carrier in a seated and retained position. The receptacle region may be formed as a recessed cavity, pocket, or opening having a geometry complementary to the carrier body. The receptacle region may include one or more peripheral walls, support surfaces, or structural ribs configured to stabilize the carrier during use.

The host head framework further includes a handle attachment region configured to couple the head to a toothbrush handle. The attachment region may be compatible with manual handles, powered handles, or hybrid configurations and may employ any suitable coupling mechanism. The carrier receptacle region is structurally independent of the handle attachment region such that carrier removal does not require detachment of the head from the handle.

### Carrier Receptacle Features

As illustrated in FIG. 3, when the sub-bristle carrier is removed, the carrier receptacle region of the host head framework remains exposed and accessible. The receptacle region may include one or more features, including, but not limited to, alignment guides or rails, keyed surfaces configured to prevent incorrect carrier orientation, stop surfaces configured to limit insertion depth, retention features configured to engage complementary carrier features, and load-bearing surfaces configured to distribute brushing forces. The receptacle region may be open or partially enclosed and may include smooth transitions or drainage paths to reduce accumulation of moisture or debris when the carrier is removed.

### Interface Engagement and Retention

Engagement between the carrier and the host head framework may be achieved via one or more attachment mechanisms, including, but not limited to, twist-lock or bayonet couplings, snap-fit detents, press-fit interference structures, magnetic alignment features in combination with mechanical retention elements, and hybrid mechanisms requiring compound or non-axial engagement motions. Retention forces are selected to exceed forces encountered during normal brushing, including axial, lateral, and torsional loads, while remaining low enough to permit intentional removal by the user. In some embodiments, disengagement requires a deliberate sequence of motions or alignment steps, thereby reducing the likelihood of unintended release.

### Structural Load Transfer

When the carrier is installed, brushing forces applied to the cleaning elements are transferred through the carrier body into the host head framework. The host head framework may include load-bearing surfaces or support ribs configured to distribute forces and reduce stress concentrations at the interface.

In some embodiments, the host head framework is configured such that structural loads are borne primarily by the framework rather than the carrier, thereby reducing wear on the carrier interface features and promoting consistent retention over repeated replacement cycles.

### Cross-Sectional Interface Architecture

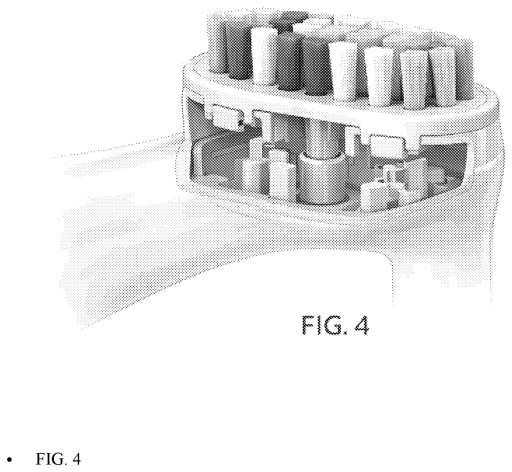

As illustrated in FIG. 4, the interface between the carrier and the host head framework may include overlapping engagement regions, undercuts, ramps, or stepped surfaces. Such features may be configured to resist axial pull-out forces, resist rotational disengagement during use, guide the carrier into a fully seated position, and provide tactile or audible feedback upon engagement. Cross-sectional architecture may further be configured to bias disengagement in directions that are externally accessible to the user while resisting disengagement forces directed toward the oral cavity.

### Exploded Assembly and Replacement

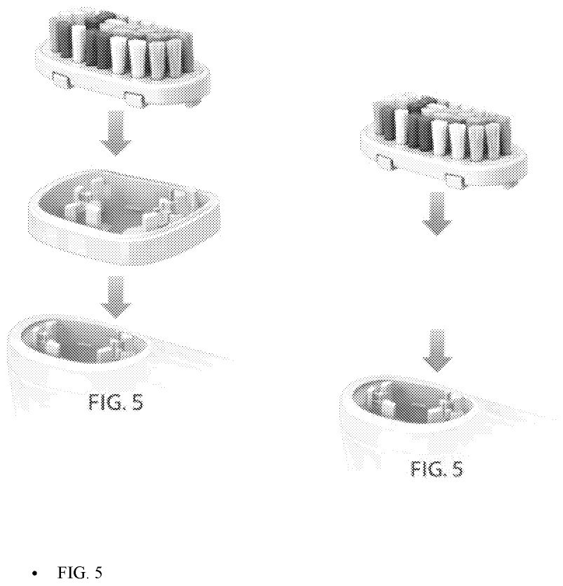

As illustrated in FIG. 5, the carrier, interface region, and host head framework may be assembled in a defined sequence. The exploded configuration demonstrates the modular nature of the architecture and the independence of the carrier from the surrounding head structure.

Replacement may be performed without tools and without disassembly of the handle or host head framework. In certain embodiments, the host head framework is configured to accept carriers of different geometries or functional types sharing a common interface architecture.

### Durability and Lifecycle Considerations

The host head framework is designed for durability over an extended service life. Interface features on the framework may be reinforced, hardened, or otherwise shaped to minimize wear relative to the carrier. In some embodiments, wear is intentionally biased toward the carrier such that replacement of the carrier restores interface performance without degradation of the framework.

The architecture anticipates repeated carrier replacement cycles and incidental user mishandling without loss of functional integrity.

### Non-Limiting Nature of Examples

The host head framework and receptacle architectures illustrated in FIGS. 2-5 are exemplary. Variations in receptacle geometry, interface configuration, material choice, and retention strategy may be employed without departing from the scope of the disclosed architecture. Features described in connection with one embodiment may be combined with features of other embodiments.

### 4.4 Retention Mechanics, Safety Architecture, and Inadvertent Detachment Mitigation

The disclosed modular architecture incorporates retention and safety characteristics that arise from structural design, interface geometry, and engagement mechanics, rather than from user instructions, warnings, or behavioral assumptions. These characteristics collectively function to resist unintended detachment of the sub-bristle carrier during normal use and to mitigate risks associated with inadvertent release.

### Retention Force Calibration

The interface between the sub-bristle carrier and the host head framework is configured to provide a retention force threshold selected to exceed forces met during normal brushing activities. Such forces may include axial pull forces, lateral shear forces, torsional loads, vibrational loads, and combinations thereof arising from manual brushing or powered head motion.

Retention force thresholds are selected such that: incidental forces encountered during use are insufficient to disengage the carrier, and intentional removal remains achievable by the user through deliberate manipulation.

Retention may be provided through one or more cooperating interface features, including mechanical interlocks, interference surfaces, ramps, detents, or hybrid mechanisms. In some embodiments, retention strength increases as brushing forces are applied, thereby providing a self-stabilizing effect.

### Multi-Axis and Compound Disengagement Motions

In certain embodiments, disengagement of the carrier requires a non-axial or compound motion, such as a combination of rotation and translation, angular alignment followed by withdrawal, or sequential engagement release. Such disengagement requirements reduce the likelihood of unintended release resulting from a single force vector applied during brushing.

By requiring deliberate alignment or motion that is unlikely to occur inadvertently during oral use, the architecture passively discourages unintended detachment without increasing removal difficulty during intentional handling.

### Geometric Biasing and Directional Stability

The interface geometry may be configured to bias retention stability in directions corresponding to oral use. For example, engagement surfaces, ramps, or undercuts may be oriented to resist forces directed toward the oral cavity while permitting disengagement in externally accessible directions.

This directional biasing reduces the likelihood that forces applied during brushing will drive the carrier toward disengagement while allowing removal when the carrier is externally accessible and intentionally manipulated by the user.

### Dimensional and Profile-Based Safety Characteristics

The sub-bristle carrier may be dimensioned and shaped such that its overall size, profile, or geometry discourages posterior oral migration in the event of release. Such characteristics may include carrier dimensions exceeding typical swallowing thresholds, widened profiles, flanged edges, or surface contours that resist rearward movement within the oral cavity.

These characteristics are structural in nature and function independently of user behavior, instructions, or warnings.

### Retention Redundancy

In some embodiments, the interface includes redundant retention features, such that disengagement requires simultaneous or sequential release of multiple interface elements. Redundant retention may be achieved through multiple detents, dual engagement surfaces, or cooperative alignment features distributed around the carrier perimeter.

Redundancy reduces the likelihood that partial wear, debris accumulation, or localized deformation will result in unintended release.

### Wear Management and Retention Longevity

The retention architecture is designed to accommodate repeated attachment and detachment cycles without significant degradation of retention performance. Wear surfaces may be reinforced, radiused, or shaped to control wear patterns over time.

In some embodiments, wear is intentionally biased toward the carrier rather than the host head framework, such that replacement of the carrier restores retention characteristics without compromising the framework. Retention features may be configured to maintain functional engagement even after partial wear.

### Failure Mode Mitigation

The architecture anticipates potential failure modes including improper insertion, partial engagement, misalignment, or incomplete seating. To mitigate such conditions, the interface may include one or more features, including, but not limited to, keyed geometries configured to prevent incorrect orientation, stop surfaces configured to limit insertion depth, tactile or audible feedback indicating full engagement, and visual alignment indicators. These features collectively reduce the likelihood of improper installation that could otherwise compromise retention.

### Passive Safety Without Instructional Dependence

Importantly, the disclosed retention and safety characteristics are achieved without reliance on user instructions, warnings, or behavioral constraints. Safety is achieved through geometry, interface mechanics, and engagement logic inherent to the architecture itself.

This approach improves reliability across varied user populations and usage scenarios and supports regulatory acceptance by minimizing reliance on user compliance for safe operation.

### Non-Limiting Nature of Safety Features

The retention and safety mechanisms described herein are exemplary and non-limiting. Variations in retention strategy, interface geometry, engagement logic, and redundancy may be employed without departing from the scope of the disclosed architecture. Features described in connection with one embodiment may be combined with features of other embodiments.

### 4.5 Hygiene, Cleaning, and User Interaction Scenarios

The disclosed modular architecture provides significant hygiene and maintenance advantages by enabling direct access to the bristle-bearing region, which is the portion of a toothbrush head most susceptible to moisture retention, debris accumulation, and biological contamination.

### Independent Access to the Bristle Base Region

Because the sub-bristle carrier is removable independently of the host head framework, regions at or near the base of the cleaning elements—typically inaccessible in permanently fixed designs—can be directly rinsed, cleaned, dried, or soaked. This access reduces the accumulation of toothpaste residue, moisture, and debris that would otherwise be trapped within recesses of a fixed head architecture.

The host head framework may likewise be rinsed or dried separately when the carrier is removed, further improving overall hygiene of the toothbrush assembly.

### Cleaning and Maintenance Scenarios

The architecture supports a variety of cleaning and maintenance scenarios, including, but not limited to, removal of the sub-bristle carrier for direct rinsing under running water, soaking of the carrier in cleaning or sanitizing solutions, air drying of the carrier separate from the host head framework, periodic replacement of the carrier without discarding the host head framework, and inspection of the carrier and interface regions for wear or residue. Such scenarios are enabled by the architecture itself and do not require specialized tools or disassembly of the toothbrush handle.

### Moisture Reduction and Drying Efficiency

By allowing separation of the carrier from the host head framework, the architecture reduces moisture retention at the bristle base and interface regions. Drying efficiency is improved by increasing airflow exposure to surfaces that are otherwise enclosed or shielded in fixed-bristle designs.

In some embodiments, the carrier and/or host head framework may include open geometries, smooth transitions, or drainage paths configured to further reduce retention of moisture and debris during and after cleaning.

### Selective Replacement and Hygiene Refresh

The architecture allows the bristle-bearing region to be selectively replaced when wear, contamination, or hygiene degradation occurs, without replacing the entire head assembly. This enables users to restore a hygienic oral-contact surface while preserving durable structural components.

Replacement carriers may be provided individually or as part of kits or assortments, allowing users to maintain hygiene through scheduled replacement, event-driven replacement, or preference-based substitution.

### User Handling and Interaction Considerations

The architecture anticipates varied user handling behaviors, including frequent removal, occasional removal, or extended periods between maintenance. Interface features may be designed to guide proper handling through tactile cues, visual alignment indicators, or intuitive engagement geometry.

The carrier may be sized and shaped to be easily grasped by the user during removal and replacement, reducing the likelihood of dropping or mishandling during cleaning.

### Mishandling and Edge-Case Scenarios

The design anticipates incidental mishandling, including partial engagement, incomplete seating, or repeated attachment attempts. Structural features described elsewhere herein cooperate to reduce the likelihood that such conditions will compromise retention or hygiene.

In some embodiments, the architecture tolerates partial debris presence or residue accumulation without loss of retention or functional performance, allowing hygiene maintenance to be performed on a flexible schedule without immediate risk.

### Compatibility Across Manual and Powered Use

The hygiene and cleaning advantages described herein apply equally to manual toothbrush heads and powered toothbrush heads. Removal of the sub-bristle carrier does not require detachment of the host head framework from the handle and does not interfere with powered motion mechanisms located elsewhere in the toothbrush assembly.

### Non-Limiting Nature of Hygiene Scenarios

The hygiene and interaction scenarios described are exemplary and non-limiting. Variations in cleaning frequency, methods, replacement schedules, and user behavior may be accommodated without departing from the scope of the disclosed architecture.

### 4.6 Design Variants, Embodiments, and Configuration Matrix

The removable and replaceable sub-bristle carrier architecture disclosed herein is intentionally modular and configurable. While primary embodiments are described in the context of oral care devices, the underlying architectural principles—namely, selective removability of a consumable cleaning interface from a durable host structure—are applicable across a wide range of form factors, configurations, and use environments.

### 4.6.1 Carrier Quantity and Arrangement

In some embodiments, a toothbrush head includes a single sub-bristle carrier seated within a defined receptacle region of the host head framework.

In other embodiments, the toothbrush head includes multiple sub-bristle carriers, each independently removable. Such carriers may be arranged in a variety of configurations, including, but not limited to, being arranged adjacently, spaced apart, aligned along a longitudinal axis, arranged symmetrically or asymmetrically, or grouped into zones within the host head framework. Multi-carrier embodiments allow selective replacement of localized regions subject to higher wear or contamination while preserving other regions of the host head framework.

### 4.6.2 Carrier Geometry Variants

The sub-bristle carrier may assume a wide variety of geometries, including, but not limited to, circular, oval, polygonal, segmented, asymmetric, contoured, tapered, and regionally thickened or thinned profiles. The geometry of the carrier may be selected based on cleaning application, interface constraints, motion characteristics, manufacturing considerations, or combinations thereof.

### 4.6.3 Carrier Motion and Functional Behavior

In certain embodiments, the sub-bristle carrier remains stationary relative to the host head framework during use. In other embodiments, the carrier may be configured to move, including, but not limited to, rotating, oscillating, pivoting, reciprocating, or responding to motion transmitted from a powered handle, wherein such motion may be driven mechanically, magnetically, or through engagement with drive features of a powered toothbrush. The removable nature of the carrier is preserved regardless of whether the carrier is stationary or dynamic during operation.

### 4.6.4 Interface Scaling and Dimensional Variability

The interface between the sub-bristle carrier and the host head framework may be scaled to accommodate a variety of configurations, including, but not limited to, compact heads, extended heads, pediatric configurations, specialty configurations, and professional or institutional formats. Such dimensional scaling does not alter the fundamental architectural relationship between the sub-bristle carrier and the host head framework as disclosed herein.

### 4.6.5 Material and Compliance Variants

The carrier may be fabricated from one or more materials, including, but not limited to, rigid polymers, elastomeric materials, hybrid rigid-compliant constructions, and multi-material assemblies. Compliance may be localized to the carrier body, interface regions, or cleaning element base, thereby enabling selective tuning of durability, comfort, and retention characteristics.

### 4.6.6 Cross-Industry Architectural Applicability

While primary embodiments are described with reference to oral care devices, the disclosed sub-bristle carrier architecture is not inherently limited to toothbrush heads. The disclosed architecture encompasses a modular cleaning interface architecture in which a consumable or wear-prone cleaning element module is removably coupled to a durable host structure, and replacement occurs at the sub-interface level rather than at the full device level.

In future embodiments, the same architectural principles may be applied to cleaning tools, hygiene implements, or surface-contact devices in non-oral environments, including, but not limited to, household cleaning implements, appliance-integrated cleaning tools, industrial or commercial brushes, and precision cleaning interfaces. Such embodiments may differ in scale, geometry, materials, and cleaning element type while preserving the core concept of a removable sub-interface carrier. These embodiments are contemplated as extensions of the disclosed architecture and may be claimed in subsequent non-provisional applications or continuations without departing from the scope of the disclosed architecture as disclosed herein. 4.6.7 Kits, Refills, and Modular Ecosystems

The architecture supports provision of a variety of commercial configurations, including, but not limited to, replacement carrier kits, assortments of carriers having differing properties, subscription-based replenishment systems, and compatibility across multiple host head frameworks. Such systems enable lifecycle management centered on the carrier rather than the full device, thereby reducing waste and extending the usable life of associated components.

### 4.6.8 Non-Limiting Nature of Embodiments

The embodiments described herein are illustrative and non-limiting. Features described in connection with one embodiment may be combined with features of any other embodiment unless expressly stated otherwise. The scope of the disclosed architecture encompasses all structural and functional equivalents consistent with the disclosed architecture.

### Single-Carrier Configurations

In certain embodiments, the toothbrush head includes a single sub-bristle carrier removably coupled to the host head framework. The carrier may occupy a central region of the head, an offset region, or substantially the entire oral-contact surface while still constituting only a portion of the overall head structure.

Single-carrier embodiments provide simplified replacement, intuitive user handling, and reduced part count, while still enabling independent removal of the bristle-bearing region for cleaning, rinsing, drying, or substitution. Such configurations are particularly well suited for compact heads, pediatric designs, and manual toothbrush implementations, though they are not limited thereto.

Segmented arrangements allow a user to remove, clean, or replace individual regions without disturbing adjacent carriers, and further reduce the need to discard durable head components when only localized bristle wear has occurred.

### Independent Vs. Interdependent Carriers

Carriers may be configured to be independently removable, such that removal of one carrier does not require removal or movement of another. Alternatively, carriers may be interdependent, wherein removal of one carrier requires partial disengagement or coordinated movement of one or more adjacent carriers.

Interdependent arrangements may be employed to enhance retention security, control removal sequence, or distribute mechanical loads across multiple interface regions. The disclosed architecture is not limited to any particular dependency relationship.

### Arrangement Relative to Host Head Geometry

The host head framework may define carrier receptacles that are coplanar, stepped, contoured, or recessed relative to one another. Carriers may be arranged to lie flush with the surrounding head surface, recessed below it, or raised above it, depending on design goals.

Spacing between adjacent carriers may be minimal to present a continuous cleaning surface, or intentionally spaced to promote drainage, airflow, or debris clearance between carriers when removed or rinsed.

### Functional Implications of Quantity and Arrangement

The number and arrangement of sub-bristle carriers may be selected to refine one or more performance characteristics, including, but not limited to, hygiene and drying efficiency, replacement cost and sustainability, user customization and modularity, manufacturability and assembly, and compatibility with manual or powered toothbrush architectures. Importantly, the disclosed architecture contemplates all carrier quantity and arrangement combinations that preserve the principle of selectively removable sub-bristle modules working with a larger host head framework, regardless of exact count, geometry, or spatial relationship.

### Thickness and Profile Variations

The carrier body may exhibit one or more thickness or profile characteristics, including, but not limited to, uniform thickness across its surface, variable thickness across different regions, tapered profiles, stepped profiles, and contoured profiles. Thickness variation may be employed to reinforce interface regions, control flexibility, accommodate internal features, or manage load distribution during use. In certain embodiments, regions near the interface may be thicker or structurally reinforced, while bristle-support regions may be thinner or more compliant.

### Edge and Perimeter Geometry

The perimeter of the carrier may include one or more features, including, but not limited to, smooth continuous edges, chamfered or radiused transitions, keyed or notched features, and protrusions or recesses configured for engagement with the host head framework. Perimeter geometry may serve multiple functions, including alignment, retention, tactile feedback, sealing, and resistance to unintended disengagement.

### Surface Contour and Topography

The carrier body surface from which cleaning elements extend may include one or more configurations, including, but not limited to, planar, concave, convex, undulating, and regionally contoured surfaces. Surface contouring may be selected to accommodate bristle placement, distribute contact forces, or cooperate with surrounding head geometry when installed. Importantly, the geometry of the carrier body is independent of the geometry of the cleaning elements and may be optimized separately.

### Single-Piece Vs. Multi-Segment Carrier Bodies

In some embodiments, the carrier body is formed as a single, unitary component. In other embodiments, the carrier body comprises multiple interconnected segments, which may be rigidly connected, flexibly connected, or selectively articulated. Multi-segment carriers may allow local compliance, improved seating, or tolerance to dimensional variation without compromising removability.

### Compatibility Across Carrier Shapes

A host head framework may be configured to accept one or more carrier geometries, including, but not limited to, a single carrier geometry or multiple carrier geometries sharing a common interface standard. This configuration allows different carrier shapes to be interchanged within the same host head framework, thereby enabling customization, specialization, or iterative replacement without altering the surrounding head structure.

### Geometry as a Functional Variable

Carrier geometry may be selected or modified to optimize one or more performance characteristics, including, but not limited to, ease of removal and handling, resistance to unintended disengagement, interface durability, hygiene and clean-ability, and manufacturability and assembly yield. No single geometry is required to practice the disclosed architecture, and all carrier geometries that preserve the removable sub-carrier relationship with a host head framework are contemplated within the scope of the disclosed architecture.

### Non-Limiting Nature of Geometry Examples

The geometries described herein are illustrative rather than restrictive. Features described in connection with one carrier geometry may be combined with features of other geometries unless expressly stated otherwise. Structural equivalents capable of performing substantially the same function in substantially the same way are contemplated.

The host head framework may define discrete receptacle regions for each carrier, each having its own alignment features, retention structures, and stop surfaces. Interface tolerances may be independently tuned for each carrier.

### Interdependent Carrier Configurations

In other embodiments, two or more carriers are interdependent, such that removal of one carrier requires partial or complete disengagement of one or more adjacent carriers. Interdependence may be structural, mechanical, or geometric in nature.

By way of non-limiting example, such interdependence may arise where one carrier physically blocks removal of another, retention features overlap or share engagement surfaces, carriers are configured to interlock when installed, or removal requires a coordinated sequence or compound motion.

Interdependent configurations may be used to provide one or more functional advantages, including, but not limited to, enhancing retention security, distributing mechanical loads across multiple carriers, reducing the likelihood of unintended detachment, and enforcing deliberate removal behavior.

### Conditionally Interdependent Configurations

In certain embodiments, carriers are conditionally interdependent, such that they behave independently during normal use but exhibit interdependence during removal or installation. For example, a first carrier may be removable only after a second carrier is partially disengaged, or carriers may require alignment into a specific orientation before any may be removed.

Conditional interdependence allows a balance between ease of maintenance and retention robustness and may be selected based on anticipated user behavior or safety considerations.

### Functional Coupling Between Carriers

Carriers may be functionally coupled without being mechanically interdependent. For instance, carriers may share one or more functional relationships, including, but not limited to, common load-bearing surfaces, shared alignment references, coordinated motion characteristics, and synchronized replacement intervals. Functional coupling does not require simultaneous removal and does not limit the removability of individual carriers unless expressly configured otherwise.

### Carrier Interaction With Host Head Framework

Whether independent or interdependent, all carriers cooperate with the host head framework to maintain a unified oral-contact surface during use. The framework may include features that constrain relative carrier movement, limit rotational freedom, or define permissible insertion and removal paths.

The host head framework may further include features that bias carriers toward a seated position under normal use conditions, regardless of whether carriers are independently or interdependently arranged.

### Design Flexibility and Non-Limiting Scope

The disclosed architecture expressly contemplates all combinations of independent, interdependent, and conditionally interdependent carrier relationships, including hybrid arrangements within a single head assembly. Features described in connection with one configuration may be combined with features of another unless expressly stated otherwise.

The selection of carrier dependency is a design choice and does not limit the fundamental architecture of a removable sub-bristle carrier interfacing with a durable host head framework.

### 4.7 Interface Durability, Wear, and Failure Mitigation

The removable and replaceable sub-bristle carrier architecture is designed to withstand repeated attachment and detachment cycles over the operational life of the toothbrush head while maintaining reliable retention, alignment, and hygiene performance.

### Repeated Attachment and Detachment Cycles

The interface between the sub-bristle carrier and the host head framework is configured to tolerate numerous intentional removal and reinstallation cycles without loss of function. Such cycles may occur daily, weekly, or intermittently, depending on user hygiene practices and replacement schedules.

Interface geometries, materials, and engagement features may be selected to provide one or more performance characteristics, including, but not limited to, resisting deformation, limiting material creep, maintaining dimensional stability, and preserving retention force over time.

In some embodiments, the interface is designed to preferentially wear the carrier rather than the host head framework, such that replacement of the carrier restores interface integrity without requiring replacement of the host head framework.

### Retention Force Stability

Retention forces may be selected to balance competing functional considerations, including but not limited to, secure engagement during normal brushing forces, resistance to unintended disengagement, and ease of intentional removal by a user. Retention elements may include detents, interference surfaces, compliant features, magnetic biasing elements, or combinations thereof. The retention force may be distributed across multiple engagement points to reduce localized stress and wear.

In certain embodiments, retention force may be maintained within a target range across the service life of the carrier, even as surface wear occurs.

### Wear Surfaces and Load Distribution

The interface region may include dedicated wear surfaces designed to absorb repeated mechanical interaction. Such surfaces may be reinforced, thickened, textured, or composed of materials selected for abrasion resistance.

Load-bearing surfaces may be distributed across the interface to avoid concentration of stress at a single point. In multi-carrier embodiments, load distribution may occur across adjacent carriers or shared framework structures.

### Alignment Preservation Over Time

Alignment features such as keys, guides, rails, or asymmetric mating geometries may be configured to preserve proper seating even as minor wear occurs. These features ensure that the carrier consistently sits in the intended orientation and depth after repeated use.

Stop surfaces may be incorporated to prevent over-insertion and to maintain consistent positioning relative to the host head framework.

### Mitigation of Loosening and Rattle

The architecture may include biasing features, compliant interface regions, or preload mechanisms that maintain contact pressure between mating surfaces. Such features reduce rattle, micro-movement, or noise that could otherwise develop as components wear.

In some embodiments, elastomeric regions or resilient elements compensate for tolerance variation and wear accumulation.

### Failure Mode Anticipation

The design anticipates potential failure modes, including, but not limited to, gradual reduction in retention force, interface fatigue or cracking, debris accumulation affecting seating, and dimensional variation due to temperature or moisture exposure.

Mitigation strategies may include one or more features, including, but not limited to, redundant retention features, self-cleaning interface geometries, tolerance compensation features, and selection of materials having favorable environmental stability, thereby maintaining functional performance over time.

### User-induced Stress and Misuse

The interface is designed to tolerate incidental misuse, including angled insertion, partial engagement, or uneven removal forces. Interface geometry may guide the carrier into proper alignment and discourage incorrect seating.

Even in the presence of partial debris or residue, the interface may remain functional, allowing continued use until cleaning or replacement is performed.

### Non-Catastrophic Degradation

In preferred embodiments, degradation of the interface occurs gradually and predictably, favoring continued safe operation rather than sudden failure. The carrier may exhibit increased ease of removal or visible wear indicators prior to any loss of retention integrity.

This non-catastrophic behavior supports safe use and timely replacement without compromising the host head framework.

### Applicability Across Manual and Powered Devices

All durability, wear, and mitigation features described herein apply to both manual and powered toothbrush embodiments. The removable carrier interface may coexist with powered motion mechanisms without interfering with their operation or reliability.

### Non-limiting Nature of Interface Designs

The interface durability strategies described are exemplary and non-limiting. Structural, material, and geometric equivalents capable of achieving similar durability and wear mitigation outcomes are contemplated within the scope of the disclosed architecture.

### 4.8 Manufacturing and Assembly Pathways

The removable sub-bristle carrier architecture is compatible with a wide range of manufacturing techniques, materials, and assembly sequences. No single manufacturing method is required to practice the disclosed architecture, and the disclosed architecture is intentionally agnostic to fabrication approach.

### Carrier Manufacturing Methods

The sub-bristle carrier may be manufactured using one or more techniques, including, but not limited to, injection molding, over molding, multi-shot molding, additive manufacturing, compression molding, and hybrid molding and assembly processes.

In some embodiments, the carrier body and the cleaning elements are formed as a single integral component. In other embodiments, the carrier body is formed separately from the cleaning elements, which are subsequently secured thereto using known tufting, anchoring, fusion, or bonding techniques.

Multi-material construction may be employed to selectively localize stiffness, compliance, or wear resistance within different regions of the carrier.

### Host Head Framework Manufacturing

The host head framework may be manufactured independently of the carrier using one or more techniques, including, but not limited to, injection molding, over molding, structural molding with embedded features, and additive manufacturing for prototyping or low-volume production. The host head framework may be fabricated as a single unitary component or as an assembly of multiple components joined together prior to carrier installation.

### Material Selection

Materials for the carrier and host head framework may include one or more materials, including, but not limited to, thermoplastics, elastomers, engineering polymers, composite materials, and antimicrobial or treated materials. Material selection may be driven by one or more factors, including durability, compliance, hygiene, manufacturability, cost, environmental stability, and compatibility with repeated removal and replacement cycles. In some embodiments, unconventional materials may be used for the carrier and host head framework to bias wear toward the carrier and preserve longevity of the host structure.

### Assembly Sequences

Assembly of the toothbrush head may occur in one or more stages, including, but not limited to, fabrication of the host head framework, fabrication of one or more sub-bristle carriers, installation of the carrier(s) into the host head framework, and attachment of the assembled head to a handle. In some embodiments, carriers are installed at the factory prior to distribution. In other embodiments, carriers are packaged separately and installed by the user prior to first use.

### Tolerance Management and Quality Control

Manufacturing tolerances may be managed through one or more approaches, including, but not limited to, controlled interface geometries, compliant features, biasing elements, and material selection. Quality control procedures may include, but are not limited to, inspection of carrier dimensions, interface engagement force, and seating alignment to ensure consistent performance across production batches.

### Scalability and Production Volume

The architecture supports both low-volume and high-volume production. Carrier designs may be updated, iterated, or specialized without retooling the host head framework, enabling rapid product variation and scalable manufacturing strategies.

### Compatibility With Existing Manufacturing Infrastructure

The disclosed system may be produced using existing toothbrush manufacturing infrastructure with minimal modification. This compatibility facilitates adoption by established manufacturers while preserving the ability to introduce proprietary carrier designs.

### Non-limiting Nature of Manufacturing Examples

The manufacturing and assembly pathways described herein are illustrative and non-limiting. Equivalent fabrication and assembly techniques capable of producing a removable sub-bristle carrier interfacing with a host head framework are contemplated within the scope of the disclosed architecture.

### 4.9 Kits, Refills, and Commercial Systems

The removable sub-bristle carrier architecture enables modular commercial configurations that decouple consumable cleaning elements from durable structural components. The disclosed architecture is therefore well suited for distribution as individual components, kits, refill systems, and integrated commercial offerings.

### Carrier Refill Systems

In some embodiments, the sub-bristle carrier is provided as a consumable refill component separate from the host head framework. Replacement carriers may be sold individually or in multi-unit packs.

Refill carriers may be identical to an original carrier or may differ in cleaning characteristics, material composition, geometry, stiffness, or intended use case. This enables selective replacement without discarding the host head framework.

### Multi-Carrier Kits

The disclosed architecture may be provided as a kit comprising a host head framework and a plurality of interchangeable sub-bristle carriers. Carriers within a kit may vary according to one or more characteristics, including, but not limited to, geometry, bristle configuration, intended cleaning function, wear profile, and user preference. Such kits allow users to interchange carriers over time based on hygiene, wear, or desired cleaning behavior.

### Specialized Carrier Sets

Carrier sets may be configured for specific use scenarios, including, but not limited to, daily hygiene use, deep cleaning, sensitive use, and specialty or condition-specific use. Specialized carriers may be visually distinguishable, color-coded, or physically keyed to indicate intended use while remaining mechanically compatible with the same host head framework.

### System-Level Product Offerings

The removable carrier architecture may be integrated into broader oral care systems comprising one or more components, including, but not limited to, toothbrush handles, host head frameworks, multiple carrier options, storage containers, and cleaning or drying accessories. System-level offerings may be packaged as complete starter kits with optional refill programs or subscription-based replacement schedules, thereby enabling ongoing replenishment of sub-bristle carriers.

### Aftermarket and Third-Party Compatibility

In some embodiments, the carrier-host interface may be standardized or licensed to permit third-party manufacture of compatible carriers. In other embodiments, the interface may be proprietary to control performance, quality, and safety.

The architecture supports both open and closed ecosystem models depending on commercial strategy.

### Retail and Professional Distribution Models

Carriers and associated systems may be distributed through one or more channels, including, but not limited to, consumer retail channels, professional or clinical environments, direct-to-consumer platforms, and subscription services. In professional settings, carriers may be provided as single-use or limited-use components for hygiene control.

### Packaging and Identification Features

Carriers and kits may include one or more packaging or identification features, including, but not limited to, tamper-evident seals, hygiene indicators, use-cycle indicators, and compatibility markings. Such features may assist users in selecting appropriate carriers and maintaining hygienic practices.

### Lifecycle Management

The modular architecture supports lifecycle optimization through one or more approaches, including, but not limited to, reducing waste, extending host head framework lifespan, and encouraging timely replacement of high-wear components. In some embodiments, the carrier is configured as a disposable element while the host head framework remains in service over extended periods, thereby reducing overall material consumption.

### Commercial Flexibility Statement

The disclosed architecture is not limited to any particular commercial configuration. Any combination of carriers, host head frameworks, kits, refill systems, or distribution models enabled by the removable sub-bristle carrier architecture is contemplated within the scope of the disclosure.

### 4.10 Methods Enabled by the Architecture

The removable and replaceable sub-bristle carrier architecture enables multiple methods of use, maintenance, replacement, hygiene management, and system operation that are not possible in toothbrush heads having permanently fixed bristle structures. The following methods are enabled by the disclosed architecture and are expressly contemplated as part of the disclosed architecture. 4.10.1 Method of Maintaining Oral Hygiene Devices

In one method, a user maintains an oral care device by disengaging a sub-bristle carrier from a host head framework, separating the bristle-bearing portion from the host head while leaving the host head attached to a handle, directly cleaning the carrier independently of the host head, and reattaching the carrier to the host head framework for continued use. This method enables improved access to the bristle base region and reduces retained moisture and debris compared to non-removable bristle architectures.

### 4.10.2 Method of Cleaning a Bristle-Bearing Component

A method of cleaning a bristle-bearing component includes removing the sub-bristle carrier from the host head framework, exposing previously inaccessible interfaces between bristles and the carrier body, rinsing, soaking, or otherwise cleaning the carrier independently of the host head framework, and drying the carrier prior to reinstallation. The method allows more effective hygiene management without requiring disassembly of the entire toothbrush head.

### 4.10.3 Method of Replacing Worn Cleaning Elements

A method of replacing worn cleaning elements comprises identifying wear or contamination localized to the sub-bristle carrier, disengaging the carrier from the host head framework, discarding or recycling the carrier, and installing a replacement carrier while retaining the host head framework. This method decouples consumable bristle structures from durable head components, thereby reducing waste and extending product lifespan.

### 4.10.4 Method of Selectively Changing Cleaning Interfaces

In some embodiments, a method includes providing multiple sub-bristle carriers having differing cleaning characteristics, selecting a carrier based on a desired cleaning behavior or use context, installing the selected carrier onto a common host head framework, and performing oral cleaning using the selected carrier. This method supports interchangeability of cleaning interfaces without replacing the full toothbrush head.

### 4.10.5 Method of Preventing Inadvertent Detachment During Use

A method of reducing unintended detachment includes configuring the carrier-host interface to require a deliberate, non-axial disengagement motion, biasing retention features to remain seated under forces encountered during brushing, and orienting disengagement pathways such that release occurs only when the carrier is externally accessible. The method relies on passive structural design rather than user instruction or warnings.

### 4.10.6 Method of Assembling a Modular Toothbrush Head

A method of assembling a modular toothbrush head includes providing a host head framework defining a carrier receptacle, aligning a sub-bristle carrier with the receptacle using keyed or asymmetrical features, engaging retention structures to secure the carrier, and verifying proper seating via tactile, audible, or visual feedback. Assembly may be performed by manufacturers, retailers, or end users.

### 4.10.7 Method of Providing Replacement Systems

A method of supplying oral care components includes offering sub-bristle carriers as standalone consumable items, providing kits comprising a host head framework and multiple carriers, and distributing carriers through refill programs or subscription models. This method supports modular commercial ecosystems enabled by the architecture.

### 4.10.8 Method of Managing Hygiene Over Time

In some embodiments, a method includes periodically removing the sub-bristle carrier for inspection or cleaning, rotating between multiple carriers to allow drying between uses, and replacing carriers at predetermined intervals independent of the host head framework. This method reduces microbial accumulation associated with retained moisture.

### 4.10.9 Method of Cross-Platform Implementation

The architecture enables a method of implementing removable cleaning modules across different device platforms by providing a standardized carrier-host interface, adapting carrier geometry to different head frameworks, and enabling replacement of localized cleaning elements while preserving larger system structures. This method is applicable to manual, powered, and hybrid devices and supports expansion beyond a single device category.

### 4.10.10 Interpretive Method Scope Statement

The methods described herein may be performed in any order unless expressly stated otherwise. Steps may be combined, omitted, repeated, or performed concurrently. Methods described in connection with oral care devices are not limited to a particular handle type or motion system.

### 4.11 Scope, Variations, and Interpretive Statements

The foregoing detailed description is intended to illustrate representative embodiments of the removable and replaceable sub-bristle carrier architecture and is not intended to be limiting. Variations, modifications, substitutions, and equivalents will be apparent to those skilled in the art in light of the present disclosure.

Features described in connection with one embodiment may be combined with features of other embodiments unless expressly stated otherwise. Structural elements may be omitted, reordered, subdivided, or integrated without departing from the scope of the disclosed architecture. Dimensions, shapes, materials, and relative arrangements may vary to accommodate different device formats, manufacturing constraints, or user preferences.

The disclosed architecture is not limited to a particular toothbrush handle type, motion system, or actuation mechanism and is compatible with manual, powered, and hybrid oral care devices. The disclosed architecture is applicable wherever selective replacement of a localized cleaning interface is advantageous while preserving a larger supporting structure.

Unless otherwise indicated, the terms “comprising,” “including,” and “having” are open-ended and non-exclusive; singular terms include plural embodiments; references to “a” or “one” component include multiple such components; and references to attachment, coupling, or engagement include both direct and indirect connections.

The disclosed architecture is susceptible of industrial application and may be manufactured and used in any geographic jurisdiction. The scope of protection is defined solely by the claims that follow and their equivalents.

I show a modular oral care architecture incorporating a removable and replaceable sub-bristle carrier that forms only a portion of a toothbrush head. The sub-bristle carrier supports primary oral-contact cleaning elements and is detachably coupled to a host toothbrush head structure via a defined interface. The architecture permits selective removal and replacement of the sub-bristle carrier while the host toothbrush head structure remains attached to a toothbrush handle. The disclosed systems, components, methods, and replacement kits improve hygiene, reduce waste, and enable modular replacement of consumable cleaning elements without requiring replacement of the entire toothbrush head. The architecture is compatible with manual, powered, and hybrid toothbrushes.

What is claimed is:

1. A removable sub-bristle carrier for an oral care device, comprising: a carrier body defining a finite thickness and a perimeter; a plurality of oral-contact cleaning elements supported by the carrier body and extending from a first surface thereof; and at least one coupling interface formed on or within the carrier body and configured to removably engage a complementary interface associated with a host toothbrush head structure, wherein the sub-bristle carrier is dimensioned and configured to form only a portion of a toothbrush head and to remain selectively removable independently of the host toothbrush head structure.

2. A modular toothbrush head system, comprising of a host toothbrush head structure configured for attachment to a toothbrush handle; and at least one removable sub-bristle carrier detachably coupled to the host toothbrush head structure, wherein the sub-bristle carrier supports primary oral-contact cleaning elements, wherein the host toothbrush head structure remains attached to the toothbrush handle during removal and replacement of the sub-bristle carrier, and wherein the system permits selective removal and replacement of the sub-bristle carrier without removal or replacement of the host toothbrush head structure.

3. An oral care device, comprising of a host toothbrush head structure defining a carrier receptacle region; and a removable sub-bristle carrier configured to be positioned within the carrier receptacle region, wherein the carrier receptacle region and the removable sub-bristle carrier define complementary engagement features configured to resist unintended detachment under forces encountered during normal oral cleaning and to permit intentional disengagement only through a deliberate removal motion distinct from forces generated during brushing.

4. A method of maintaining an oral care device, comprising of removably disengaging a sub-bristle carrier from a host toothbrush head structure while the host toothbrush head structure remains attached to a toothbrush handle; cleaning, rinsing, soaking, drying, or otherwise treating the sub-bristle carrier independently of the host toothbrush head structure; and re-engaging the sub-bristle carrier with the host toothbrush head structure for continued use.

5. A replacement system for an oral care device, comprising of a plurality of removable sub-bristle carriers each configured to detachably couple to a common host toothbrush head structure, wherein each removable sub-bristle carrier is independently installable onto the host toothbrush head structure to enable continued use of the host toothbrush head structure without replacement thereof.

6. An oral care device comprising a removable sub-bristle carrier, wherein the removable sub-bristle carrier and a host toothbrush head structure are structurally configured such that detachment of the removable sub-bristle carrier is biased to occur only when the removable sub-bristle carrier is externally accessible to a user and not during active oral cleaning.

7. The removable sub-bristle carrier of claim 1, wherein the coupling interface comprises a twist-lock or bayonet-style engagement.

8. The removable sub-bristle carrier of claim 1, wherein the coupling interface comprises a snap-fit detent requiring deformation of at least one resilient portion during engagement.

9. The removable sub-bristle carrier of claim 1, wherein the coupling interface comprises a magnetic alignment structure combined with a mechanical retention feature.

10. The removable sub-bristle carrier of claim 1, wherein removal of the carrier requires a compound motion including both rotational and axial displacement.

11. The removable sub-bristle carrier of claim 1, wherein the carrier body includes keyed or asymmetric features preventing incorrect installation orientation.

12. The removable sub-bristle carrier of claim 1, wherein the carrier body defines a circular, oval, polygonal, segmented, or asymmetric geometry.

13. The removable sub-bristle carrier of claim 1, wherein the carrier body is configured to rotate or oscillate relative to the host toothbrush head structure when installed.

14. The removable sub-bristle carrier of claim 1, wherein the carrier body is configured to remain stationary relative to the host toothbrush head structure during use.

15. The removable sub-bristle carrier of claim 1, wherein the carrier body is formed from rigid, semi-rigid, elastomeric, or hybrid materials.

16. The modular toothbrush head system of claim 2, wherein the system includes a plurality of removable sub-bristle carriers supported by the host toothbrush head structure.

17. The modular toothbrush head system of claim 2, wherein the removable sub-bristle carriers are independently removable from the host toothbrush head structure.

18. The modular toothbrush head system of claim 2, wherein the host toothbrush head structure includes alignment guides or stop surfaces configured to ensure repeatable seating of the sub-bristle carrier.

19. The modular toothbrush head system of claim 2, wherein retention forces between the carrier and the host toothbrush head structure exceed forces generated during normal brushing.

20. The modular toothbrush head system of claim 2, wherein the system is compatible with manual toothbrush handles, powered toothbrush handles, or hybrid handles.

21. The modular toothbrush head system of claim 2, wherein the host toothbrush head structure includes load-bearing structures separate from the sub-bristle carrier.

22. The modular toothbrush head system of claim 2, wherein the system permits selective replacement of the sub-bristle carrier without exposure of internal head structures.

23. The oral care device of claim 3, wherein the complementary engagement features comprise non-axial disengagement pathways.

24. The oral care device of claim 3, wherein disengagement requires alignment of the sub-bristle carrier with a release orientation distinct from brushing orientations.

25. The oral care device of claim 3, wherein the engagement features include retention thresholds selected to permit repeated attachment and detachment cycles without structural failure.

26. The oral care device of claim 3, wherein the engagement features are configured to bias detachment toward an externally accessible direction.

27. The oral care device of claim 3, wherein the engagement features include wear-tolerant contact surfaces.

28. The oral care device of claim 3, wherein tactile, audible, or visual feedback is provided upon successful seating of the sub-bristle carrier.

29. The oral care device of claim 3, wherein the engagement features include asymmetric geometry preventing reverse installation.

30. The method of claim 4, wherein removably disengaging the sub-bristle carrier comprises performing a non-axial or compound removal motion.

31. The method of claim 4, wherein cleaning the sub-bristle carrier comprises rinsing, soaking, or applying a cleaning solution to the carrier independent of the host toothbrush head structure.

32. The method of claim 4, further comprising drying the sub-bristle carrier separately from the host toothbrush head structure prior to re-engagement.

33. The method of claim 4, wherein re-engaging the sub-bristle carrier comprises aligning keyed or asymmetric interface features prior to seating.

34. The method of claim 4, wherein the host toothbrush head structure remains attached to a toothbrush handle throughout the method.

35. The method of claim 4, further comprising rotating between multiple sub-bristle carriers to allow drying between uses.

36. The method of claim 4, wherein the method is performed periodically as part of routine oral hygiene maintenance.

37. The method of claim 4, further comprising replacing the sub-bristle carrier while retaining the host toothbrush head structure.

38. The method of claim 4, wherein the oral care device is manual, powered, or hybrid.

39. The replacement system of claim 5, wherein the plurality of removable sub-bristle carriers are packaged as a refill kit.

40. The replacement system of claim 5, wherein the plurality of removable sub-bristle carriers comprise carriers having differing geometries or cleaning characteristics.

41. The replacement system of claim 5, wherein the system further comprises instructions or indicators for selecting a carrier based on intended use.

42. The replacement system of claim 5, wherein the plurality of removable sub-bristle carriers are compatible with a single host toothbrush head structure.

43. The replacement system of claim 5, wherein the system is configured for subscription-based replacement of sub-bristle carriers.

44. The replacement system of claim 5, wherein the plurality of removable sub-bristle carriers are individually packaged.

45. The replacement system of claim 5, wherein the system further comprises a host toothbrush head structure provided together with at least one removable sub-bristle carrier.

46. The replacement system of claim 5, wherein the system is configured to extend a usable lifespan of the host toothbrush head structure by selective replacement of the sub-bristle carrier.
